(19) United States
(12) Patent Application Publication
(10) Pub. No.: US 2026/0005388 A1
(43) Pub. Date: Jan. 1, 2026

(54) BATTERY ASSEMBLY INCLUDING PRISMATIC CAN BATTERY CELLS HAVING A SIDE MOUNTED VENT CAP

(71) Applicant: GM GLOBAL TECHNOLOGY OPERATIONS LLC, Detroit, MI (US)

(72) Inventors: SriLakshmi KATAR, Troy, MI (US); Binsong LI, Troy, MI (US); Liang Xi, Northville, MI (US); Ryan Patrick Hickey, Austin, TX (US); Taylor Reed Garrick, Bloomfield Hills, MI (US)

(21) Appl. No.: 18/754,310

(22) Filed: Jun. 26, 2024

(51) Int. Cl. H01M 50/375; H01M 10/613; H01M 10/647; H01M 10/6555; H01M 10/6557; H01M 50/103; H01M 50/209; H01M 50/249

(52) U.S. Cl. CPC H01M 50/375; H01M 10/613; H01M 10/647; H01M 10/6555; H01M 10/6557; H01M 50/103; H01M 50/209; H01M 50/249

(57) ABSTRACT

A prismatic can battery cell in accordance with the present disclosure includes an upper surface, a lower surface, a first wide face side surface, a second wide face side surface, a first narrow face side surface, and a second narrow face side surface. A vent cap is arranged on one of the first narrow face side surface and the second narrow face side surface.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery assemblies and, more particularly, to a battery assembly including prismatic can battery cells having a side mounted vent.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators arranged in a battery cell stack located in a battery cell enclosure (or cell can). The cathode electrodes include a cathode active material layer arranged on a cathode current collector. The anode electrodes include an anode active material layer arranged on an anode current collector. The cathode and anode electrodes are connected to cathode and anode terminals arranged on an outer surface of the enclosure.

Battery modules or packs typically include a housing that supports and surrounds the battery cells. The terminals of the battery cells are interconnected to provide a desired output voltage.

### SUMMARY

A prismatic can battery cell in accordance with the present disclosure includes an upper surface and a lower surface arranged opposite the upper surface. The lower surface is spaced from the upper surface by a first distance defined along a first axis. A first wide face side surface extends between and connects the upper surface and the lower surface. A second wide face side surface is arranged opposite the first wide face side surface. The second wide face side surface is spaced from the first wide face side surface a second distance defined along a second axis that is substantially perpendicular to the first axis. A first narrow face side surface extends between and connects the upper surface and the lower surface and is joined with the first wide face side surface and the second wide face side surface. A second narrow face side surface extends between and connects the upper surface and the lower surface and is joined with the first wide face side surface and the second wide face side surface. The second narrow face side surface being spaced from the first narrow face side surface a third distance defined along a third axis that is substantially perpendicular to each of the first axis and the second axis. The first distance is greater than each of the second distance and the third distance. A vent cap arranged on one of the first narrow face side surface and the second narrow face side surface.

In other features an anode terminal and a cathode terminal are mounted on the upper surface.

In other features the vent cap is arranged on the second narrow face side surface adjacent to the lower surface.

In other features the vent cap is arranged on the second narrow face side surface adjacent to the upper surface.

In other features the vent cap is arranged on the second narrow face side surface substantially equidistant from the upper surface and the lower surface.

In other features the vent cap includes a first vent cap arranged on the first narrow face side surface and a second vent cap arranged on the second narrow face side surface.

In other features a thermal runaway barrier arranged on the one of the first narrow face side surface and the second narrow face side surface, the thermal runaway barrier including an opening that registers with the vent cap.

A battery assembly, in accordance with the present disclosure, includes a housing including a base wall, a first side wall, and a second side wall opposite the first side wall. The first side wall, the second side wall, and the base wall being connected to form a battery cell receiving zone. A plurality of prismatic can battery cells is arranged in the battery cell receiving zone. Each of the plurality of prismatic can battery cells includes an upper surface and a lower surface arranged opposite the upper surface. The lower surface is spaced from the upper surface by a first distance defined along a first axis defining a height of the prismatic can battery cell. A first wide face side surface extends between and connects the upper surface and the lower surface. A second wide face side surface is arranged opposite the first wide face side surface. The second wide face side surface is spaced from the first wide face side surface a second distance defined along a second axis that is substantially perpendicular to the first axis. A first narrow face side surface extends between and connects the upper surface and the lower surface and is joined with the first wide face side surface and the second wide face side surface. A second narrow face side surface extends between and connects the upper surface and the lower surface and is joined with the first wide face side surface and the second wide face side surface. The second narrow face side surface is spaced from the first narrow face side surface a third distance defined along a third axis that is substantially perpendicular to each of the first axis and the second axis. The first distance being greater than each of the second distance and the first distance. A vent cap is arranged on one of the first narrow face side surface and the second narrow face side surface.

In other features an anode terminal and a cathode terminal are mounted on the upper surface.

In other features the vent cap is arranged on the second narrow face side surface adjacent to the lower surface.

In other features the plurality of prismatic can battery cells include a first plurality of prismatic can battery cells arranged in a first row, and a second plurality of prismatic can battery cells arranged in a second row, the second narrow face side surface of each of the first plurality of prismatic can battery cells defines a first laterally outwardly facing surface and the second narrow face side surface of each of the second plurality of prismatic can battery cells defines a second laterally outwardly facing surface.

In other features a cooling plate extends along the first laterally outwardly facing surface of the first plurality of prismatic can battery cells.

In other features the vent cap on each of the first plurality of prismatic can battery cells is arranged on the first laterally outwardly facing surface between the cooling plate and the upper surface.

In other features the cooling plate includes a first cooling plate extending along the first laterally outwardly facing surface adjacent the upper surface and a second cooling plate extending along the first laterally outwardly facing surface adjacent the lower surface, the vent cap being arranged on the first laterally outwardly facing surface of each of the first plurality of prismatic can battery cells between the first cooling plate and the second cooling plate.

In other features the cooling plate includes a width defined along the first axis, the cooling plate including a plurality of passages that are configured to carry cooling in a heat exchange relationship with each of the plurality of prismatic can battery cells.

In other features the width of the cooling plate is less than the height of each of the plurality of prismatic can battery cells forming a passage that extends substantially parallel to the plurality of passages.

In other features the width of the cooling plate is more than half the height of the battery cell.

In other features the width of the cooling plate is less than half the height of the battery cell.

In other features a first thermal runaway barrier (TRB) arranged along the first narrow face side surface of each of the prismatic can battery cells and a second TRB arranged along the second narrow face side surface of the plurality of prismatic can battery cells.

In other features the second TRB includes a plurality of openings that accommodate the vent cap on each of the prismatic can battery cells.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a left side view of a vehicle including a battery assembly having tall prismatic can battery cells provided with a side mounted vent, in accordance with a non-limiting example;

FIG. 2 is a partial elevational view of a battery assembly including prismatic can battery cells having a side mounted vent, in accordance with a non-limiting example;

FIG. 3 is an upper left perspective view of a plurality of prismatic can battery cells in operational contact with a cooling system, in accordance with a non-limiting example;

FIG. 4 is an upper left perspective view of a plurality of prismatic can battery cells in operational contact with a cooling system, in accordance with another non-limiting example; and

FIG. 5 is an upper left perspective view of a plurality of prismatic can battery cells in operational contact with a cooling system, in accordance with yet another non-limiting example; and

FIG. 6 is a partially disassembled view of a prismatic can battery cell having a first side mounted vent and a second side mounted vent, in accordance with a non-limiting example.

In the drawings, reference numbers may be reused to identify similar and/or identical elements.

### DETAILED DESCRIPTION

While prismatic can battery cells according to the present disclosure are shown in the context of electric vehicles, the prismatic can battery cells can be used in stationary applications and/or other applications.

The size and shape of enclosures can vary. Prismatic enclosures include a length distance, a width distance, and a height distance and may be formed as tall enclosures or long enclosures. For a tall enclosure, the height distance is greater than each of the width distance and the length distance. For long enclosures, the length distance is greater than each of the height distance and the width distance. The terminals for tall cells are typically arranged on an upper surface while the terminals for long cells may be arranged on upper or end surfaces.

Prismatic can battery cells typically include a vent cap. During a thermal runaway event, the vent cap bursts to allow at least one of vent gases and ejecta that may develop during thermal runaway to exit the enclosure. Given the construction of the tall cells, the vent caps are typically arranged on the upper surface or on the lower surface. Arrangement on the upper or the bottom surface provides room for cooling systems that engage side surfaces of the prismatic can battery cell.

When arranged on the upper surface, the vent cap competes with the electrodes for available space. When arranged on the lower surface, the vent cap requires that any supporting structure be provided with openings and/or passages that can transport the venting gases and/or ejecta to ambient.

Battery enclosures such as prismatic battery enclosures according to the present disclosure include a vent cap that accommodates cooling systems, allows for efficient cooling without taking up space on upper surfaces, and does not necessitate the addition of openings on lower support surfaces.

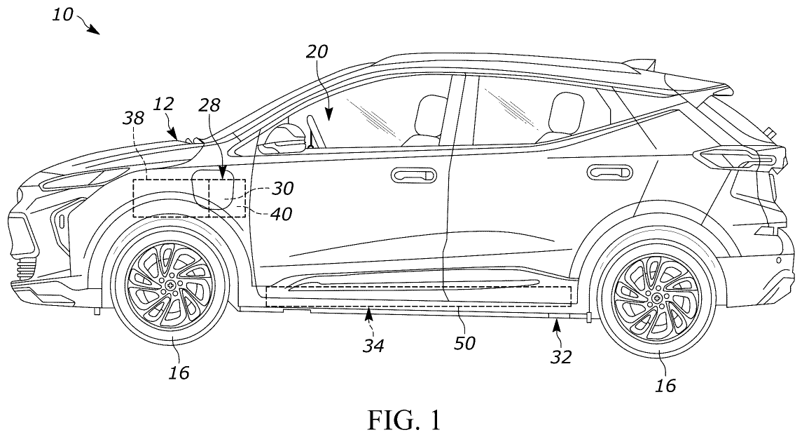

A vehicle, in accordance with a non-limiting example, is indicated generally at 10 in FIG. 1. Vehicle 10 includes a body 12 supported on a plurality of wheels, two of which are indicated at 16. Body 12 defines, in part, a passenger compartment 20. Body 12 includes a charge port cover 28 that houses a charge port 30. Vehicle 10 includes a chassis 32 that supports a battery assembly 34 electrically connected to charge port 30. Chassis 32 is further shown to support a motor 38 that is electrically connected to battery assembly 34 and a drivetrain 40. Drivetrain 40 transfers motive power from motor 38 to one or more of the plurality of wheels 16.

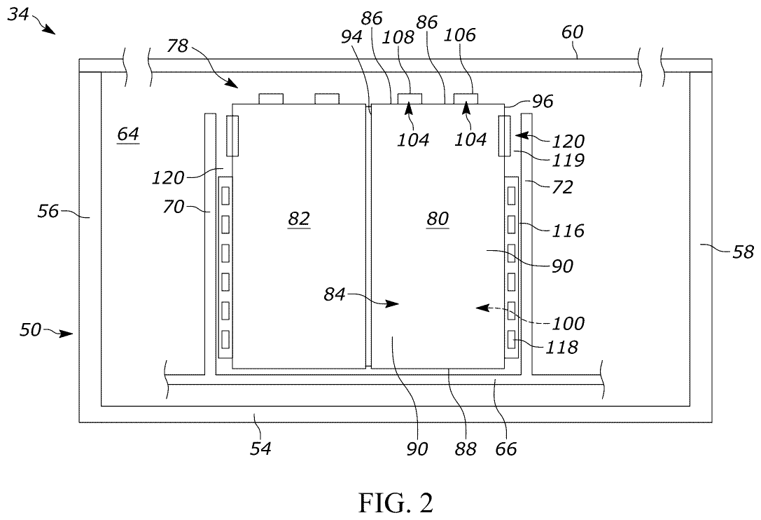

Battery assembly 34 includes a housing 50 as shown in FIG. 2. Housing 50 includes a base wall 54, a first side wall 56, a second side wall 58, and a cover 60. Additional side walls (not shown) are also present. Base wall 54, first side wall 56, second side wall 58, and cover 60, together with the additional side walls, collectively define a prismatic can battery cell receiving zone 64. Housing 50 includes a prismatic can battery cell support surface 66. A first divider wall 70 and a second divider wall 72 extend upwardly from prismatic can battery cell support surface 66. A plurality of prismatic can battery cells 78 are arranged between first divider wall 70 and second divider wall 72. The number of divider walls may vary depending on battery power requirements. As will become more fully evident herein, the plurality of prismatic can battery cells 78 take the form of tall prismatic can battery cells.

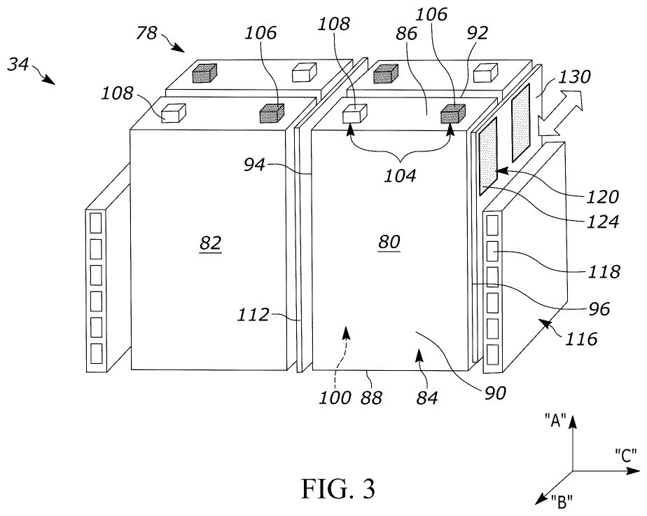

In a non-limiting example shown in FIG. 3, the plurality of prismatic can battery cells 78 includes a first plurality of prismatic can battery cells 80 arranged in a first row (not separately labeled) and a second plurality of prismatic can battery cells 82 arranged in a second row (also not separately labeled). Reference will continue to FIGS. 2 and 3 in describing a prismatic can battery cell 84 that forms part of the first plurality of prismatic can battery cells 80 with an understanding that the second plurality of prismatic can battery cells 82 may be similarly formed.

Prismatic can battery cell 84 includes an upper surface 86, a lower surface 88, a first wide face side surface 90, a second wide face side surface 92, a first narrow face side surface 94, and a second narrow face side surface 96. First narrow face side surface 94 defines a first laterally outwardly facing surface, and second narrow face side surface 96 defines a second laterally outwardly facing surface.

Upper surface 86, lower surface 88, first wide face side surface 90, second wide face side surface 92, first narrow face side surface 94, and second narrow face side surface 96 are interconnected to form a prismatic shape defining a battery interior 100 to receive the battery stack and electrolyte. Upper surface 86 is spaced from lower surface a first distance defined along a first axis “A”. First wide face side surface 90 is spaced from second wide face side surface 92 a second distance defined along a second axis “B” that is substantially perpendicular relative to first axis “A”. First narrow face side surface 94 is spaced from second narrow face side surface 96 a third distance defined along a third axis “C” that is substantially perpendicular relative to first axis “A” and second axis “B”.

In a non-limiting example, the first distance is greater than each of the second distance and the third distance defines a height of prismatic can battery cell 84. Further, the second distance is less than the third distance and defines a width of prismatic can battery cell 84, and the third distance defines a length of prismatic can battery cell 84. With this configuration, prismatic can battery cell 84 takes the form of a “tall” prismatic can battery cell having terminals 104 including a cathode 106 and an anode 108 provided on upper surface 86.

With continued reference to FIG. 3, battery assembly 34 includes a first thermal runaway barrier (TRB) 112 that is arranged between the first plurality of prismatic can battery cells 80 and the second plurality of prismatic can battery cells 82. First TRB 112 reduces heat transfer between adjacent prismatic can battery cells to provide thermal isolation. Battery assembly 34 is further shown to include a cooling plate 116 that extends between each of the second narrow face side surfaces 96 and second divider wall 72. Another cooling plate (not separately labeled) extends between each of the first narrow face side surfaces 94 and first divider wall 70. Cooling plate 116 includes a plurality of passages 118 that carry coolant (not shown) in a heat exchange relationship with each of the first plurality of prismatic can battery cells 80

The coolant reduces internal (and external) working temperatures of each prismatic can battery cell 84. In a non-limiting example, cooling plate 116 and the another cooling plate have a width defined along axis “A” that is less than the height of prismatic can battery cell 84. In a non-limiting example, the width of the cooling plate 116 and the another cooling plate is greater than half the height of the prismatic can battery cell 84. In another non-limiting example, the width of cooling plate 116 and the another cooling plate is less than half the height of prismatic can battery cell 84. With this arrangement, passages or ducts, such as shown at 119 and 120 in FIG. 2, are formed between the first plurality of prismatic can battery cells 80 and second divider wall 72 and between the second plurality of prismatic can battery cells 82 and first divider wall 70. Passages or ducts 119 and/or 120 may be used for additional cooling or as a pathway for vent gases and/or ejecta as will be detailed more fully herein.

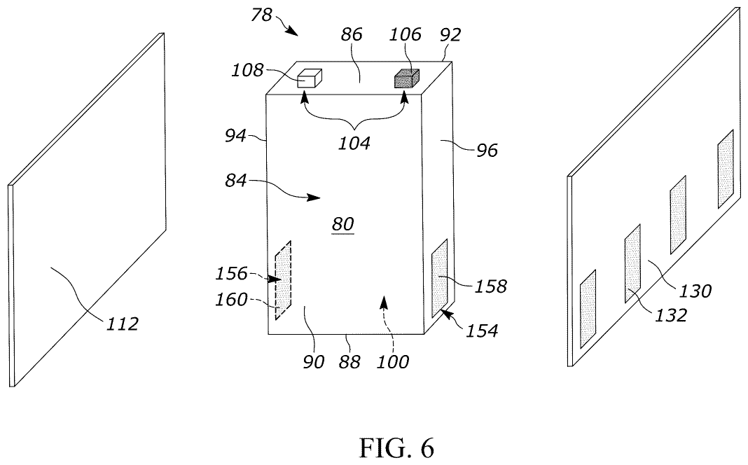

In a non-limiting example, prismatic can battery cell 84 includes a vent cap 120 provided on second narrow face side surface 96. Vent cap 120 takes the form of a covered opening 124 that is responsive to pressure that may exist in battery interior 100. If pressure in battery interior 100 exceeds a selected threshold, vent cap 120 opens allowing the vent gases and/or ejecta to escape and thereby prevent any undesired expansion of prismatic can battery cell 84. The vent gases and/or ejecta may pass along passage 117 and/or passage 118 and be ducted from housing 50. In a non-limiting example, a second TRB 130 has a plurality of openings 132 (FIG. 6) that extend about each vent cap 120 of the first plurality of prismatic can battery cells 80. Second TRB 130 is arranged between the first plurality of prismatic can battery cells 80 second divider wall 72. In a manner similar to that described herein, second TRB 130 provides thermal isolation to reduce heat transfer from the first plurality of prismatic can battery cells 80 to other prismatic can battery cells in the battery assembly.

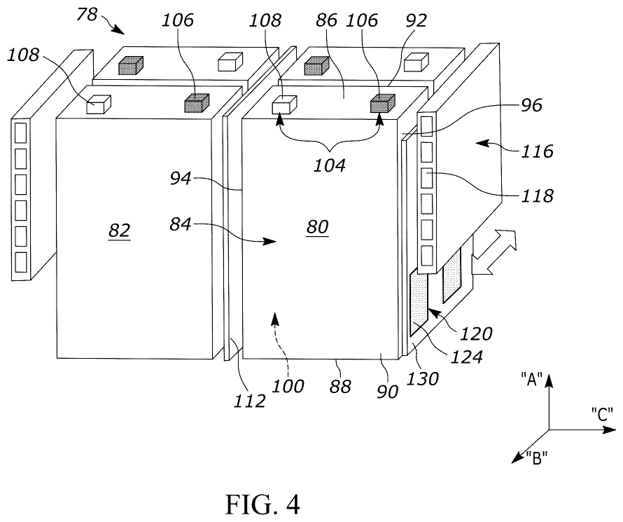

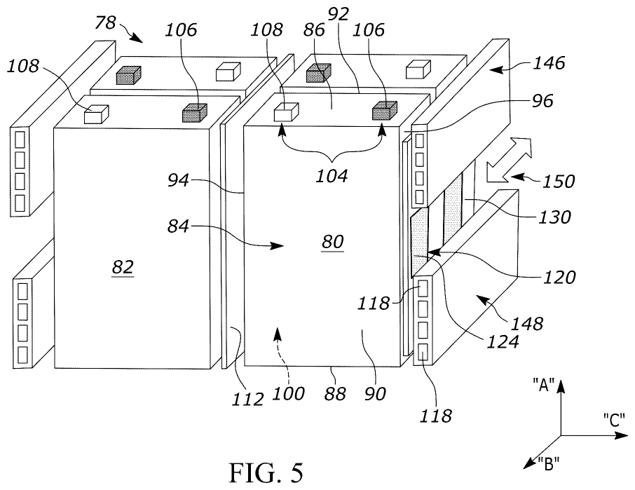

At this point, it should be understood that the location of vent cap 120 on second narrow face side surface 96 may vary. For example, FIG. 3 depicts vent cap 120 being arranged adjacent to upper surface 86. Cooling plate 116 extends from a plane adjacent to lower surface 88 to a location adjacent a lower edge of vent cap 120 and laterally a distance about equal to a length of housing 50. Vent cap 120 and cooling plate 116 may be arranged in other configuration. For example, vent cap 120 could be located adjacent to lower surface 88 as shown in FIG. 4. In such a configuration, cooling plate 116 would extend from a plane adjacent to upper surface 86 to an upper edge of vent cap 120 and laterally a distance about equal to a length of housing 50. In another non-limiting example shown in FIG. 5, battery assembly 34 may include a first cooling plate 146 and a second cooling plate 148 arranged along each second narrow face side surface 96 of the first plurality of prismatic can battery cells 80. Vent cap 120 may be arranged in a gap 150 defined between first cooling plate 146 and second cooling plate 148 mid-way between upper surface 86 and lower surface 88. Finally, as shown in FIG. 6, prismatic can battery cell 84 may include multiple vent caps including a first vent cap 154 arranged on second narrow face side surface 96 and a second vent cap 156 arranged on first narrow face side surface 94. Providing the vent cap(s) on the narrow face surface(s) of the prismatic can battery cells provides the desired pressure reliance function without interfering with battery connections or other elements that exist on the upper surface while also accommodating cooling plates that reduce cell temperatures.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terms “about” and “substantially” are intended to include the degree of error associated with measurement of the particular quantity based upon the equipment available at the time of filing the application. For example, “about” and/or “substantially” can include a range of ±8% of a given value.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A prismatic can battery cell comprising:
an upper surface;
a lower surface arranged opposite the upper surface, the lower surface being spaced from the upper surface by a first distance defined along a first axis;
a first wide face side surface extending between and connecting the upper surface and the lower surface;
a second wide face side surface arranged opposite the first wide face side surface, the second wide face side surface being spaced from the first wide face side surface a second distance defined along a second axis that is substantially perpendicular to the first axis;
a first narrow face side surface extending between and connecting the upper surface and the lower surface, and joined with the first wide face side surface and the second wide face side surface;
a second narrow face side surface extending between and connecting the upper surface and the lower surface, and joined with the first wide face side surface and the second wide face side surface, the second narrow face side surface being spaced from the first narrow face side surface a third distance defined along a third axis that is substantially perpendicular to each of the first axis and the second axis, the first distance being greater than each of the second distance and the third distance; and
a vent cap arranged on one of the first narrow face side surface and the second narrow face side surface.

2. The prismatic can battery cell according to claim 1, further comprising an anode terminal and a cathode terminal, each of the anode terminal and the cathode terminal being mounted on the upper surface.

3. The prismatic can battery cell according to claim 1, wherein the vent cap is arranged on the second narrow face side surface adjacent to the lower surface.

4. The prismatic can battery cell according to claim 1, wherein the vent cap is arranged on the second narrow face side surface adjacent to the upper surface.

5. The prismatic can battery cell according to claim 1, wherein the vent cap is arranged on the second narrow face side surface substantially equidistant from the upper surface and the lower surface.

6. The prismatic can battery cell according to claim 1, wherein the vent cap includes a first vent cap arranged on the first narrow face side surface and a second vent cap arranged on the second narrow face side surface.

7. The prismatic can battery cell according to claim 1, further comprising a thermal runaway barrier arranged on the one of the first narrow face side surface and the second narrow face side surface, the thermal runaway barrier including an opening that registers with the vent cap.

8. A battery assembly comprising:
a housing including a base wall, a first side wall, and a second side wall opposite the first side wall, the first side wall, the second side wall, and the base wall being connected to form a battery cell receiving zone; and
a plurality of prismatic can battery cells arranged in the battery cell receiving zone, each of the plurality of prismatic can battery cells comprising:
an upper surface;
a lower surface arranged opposite the upper surface, the lower surface being spaced from the upper surface by a first distance defined along a first axis defining a height of the prismatic can battery cell;
a first wide face side surface extending between and connecting the upper surface and the lower surface;
a second wide face side surface arranged opposite the first wide face side surface, the second wide face side surface being spaced from the first wide face side surface a second distance defined along a second axis that is substantially perpendicular to the first axis;
a first narrow face side surface extending between and connecting the upper surface and the lower surface, and joined with the first wide face side surface and the second wide face side surface;
a second narrow face side surface extending between and connecting the upper surface and the lower surface, and joined with the first wide face side surface and the second wide face side surface, the second narrow face side surface being spaced from the first narrow face side surface a third distance defined along a third axis that is substantially perpendicular to each of the first axis and the second axis, the first distance being greater than each of the second distance and the first distance; and
a vent cap arranged on one of the first narrow face side surface and the second narrow face side surface.

9. The battery assembly according to claim 8, further comprising an anode terminal and a cathode terminal, each of the anode terminal and the cathode terminal being mounted on the upper surface.

10. The battery assembly according to claim 8, wherein the vent cap is arranged on the second narrow face side surface adjacent to the lower surface.

11. The battery assembly according to claim 10, wherein the plurality of prismatic can battery cells include a first plurality of prismatic can battery cells arranged in a first row, and a second plurality of prismatic can battery cells arranged in a second row, the second narrow face side surface of each of the first plurality of prismatic can battery cells defines a first laterally outwardly facing surface and the second narrow face side surface of each of the second plurality of prismatic can battery cells defines a second laterally outwardly facing surface.

12. The battery assembly according to claim 11, further comprising a cooling plate extending along the first laterally outwardly facing surface of the first plurality of prismatic can battery cells.

13. The battery assembly according to claim 12, wherein the vent cap on each of the first plurality of prismatic can battery cells is arranged on the first laterally outwardly facing surface between the cooling plate and the upper surface.

14. The battery assembly according to claim 12, wherein the cooling plate includes a first cooling plate extending along the first laterally outwardly facing surface adjacent the upper surface and a second cooling plate extending along the first laterally outwardly facing surface adjacent the lower surface, the vent cap being arranged on the first laterally outwardly facing surface of each of the first plurality of prismatic can battery cells between the first cooling plate and the second cooling plate.

15. The battery assembly according to claim 12, wherein the cooling plate includes a width defined along the first axis, the cooling plate including a plurality of passages that are configured to carry cooling in a heat exchange relationship with each of the plurality of prismatic can battery cells.

16. The battery assembly according to claim 15, wherein the width of the cooling plate is less than the height of each of the plurality of prismatic can battery cells.

17. The battery assembly according to claim 16, wherein the width of the cooling plate is more than half the height of the battery cell.

18. The battery assembly according to claim 16, wherein the width of the cooling plate is less than half the height of the battery cell.

19. The battery assembly according to claim 8, further comprising a first thermal runaway barrier (TRB) arranged along the first narrow face side surface of each of the prismatic can battery cells and a second TRB arranged along the second narrow face side surface of the plurality of prismatic can battery cells.

20. The battery assembly according to claim 19, wherein the second TRB includes a plurality of openings that accommodate the vent cap on each of the prismatic can battery cells.
